(19) United States
(12) Patent Application Publication
(10) Pub. No.: US 2018/0165389 A1
(43) Pub. Date: Jun. 14, 2018

(54) METHOD AND APPARATUS FOR CIRCUIT SIMULATION

(71) Applicant: Yu Tian, Surrey (CA)

(72) Inventor: Yu Tian, Surrey (CA)

(21) Appl. No.: 15/736,276

(22) PCT Filed: Mar. 9, 2016
(86) PCT No.: PCT/CN2016/075912

§ 371 Date: Dec. 13, 2017

(30) Foreign Application Priority Data
Jun. 29, 2015 (CN) 201510368767.4

(51) Int. Cl. G06F 17/50

(52) U.S. Cl. CPC G06F 17/5009; G06F 17/5045

(57) ABSTRACT

Method and apparatus for circuit simulation, comprising: partitioning circuit into a first simulation circuit and a second simulation circuit; generating equivalent circuit of first simulation circuit at present simulation time-point based on port current/port voltage of simulation time-points prior to present simulation time-point, a pre-obtained port voltage of the first simulation circuit under port open-circuit condition/port current of the first simulation circuit under port short-circuit condition, and a pre-obtained impulse-response of the first simulation circuit; simulating circuit consisting of the equivalent circuit and the second simulation circuit based on a preset algorithm to obtain unknowns in the second simulation circuit; and obtaining unknowns in the first simulation circuit based on port current/port voltage. Comparing with prior art, this invention reduces circuit scale by equivalencing linear portion of circuit, namely, the first simulation circuit. Thereby computation amount in simulation process is reduced to meet requirements for real-time simulation.

### BACKGROUND OF THE INVENTION

### Field of the Invention

The present invention relates to simulation, and more particularly to a method and apparatus for circuit simulation.

### Description of Related Art

Circuit simulation is widely applied for checking and verifying the design of electrical circuit prior to manufacturing and deployment of electric circuit, electronic circuits and systems. In transient simulations of electric power systems, generators, transformers, loads, etc., are first modelled as combinations of circuit elements, and then simulations of the circuit representing electric power systems are performed. Therefore, transient simulation (e.g. electromagnetic transient simulation, electromechanical transient simulation, and the like) of the power system also falls into the category of circuit simulation.

The purpose of circuit simulation is to obtain response of unknowns (e.g., unknown node voltage, unknown branch current, and the like) of a circuit at a series of discrete time-points, in a given time window, with a given time-step length.

One typical existing circuit simulation method is difference equation method (or referred to by companion circuit method, numerical integration substitution method, and the like). A variation of this method in the field of power system electromagnetic transient simulation is the Electro-Magnetic Transient Program (EMTP) method. The basic principle of the method is as follows: differential equations describing dynamic characteristics of the circuit element is discretized into difference equations through numerical integration (such as trapezoidal integration, Euler method, modified Euler method, and the like). After conversion, the original dynamic elements are represented in the form of companion model (resistance, current source, or resistance and current source in parallel). Algebraic equation set of the circuit is established through nodal method or modified nodal method. In each simulation time-step, one or more matrix inversion operations of the circuit matrix (or forward-backward substitution operation if the matrix factorization table is already generated) is performed to obtain response of unknowns of the circuit at the current time-point.

Another typical existing circuit simulation method is state variable method (or referred to by state equation method, numerical integration method, and the like). According to the method, firstly, a set of variables that can fully describe circuit characteristics are selected as state variables, each of differential equation describing the state variable characteristics in the circuit is then combined into a set of differential equations. Then, numerical integration (including trapezoidal integration, Euler method, modified Euler method, Ronge-Kutta method, and the like) is performed to obtain time domain solution of the differential equation set. In each simulation time-step, the matrix of the state variable equation is subjected to one or multiple matrix derivation operation, the value of the state variable is updated, and response of the circuit at the current time-point is obtained.

For existing circuit simulation methods, in each simulation time-step, it is required to perform one or more matrix inversion operations of the circuit matrix (or forward-backward substitution operation if the matrix factorization table is already generated), or performing one or multiple matrix derivation operation on the matrix of the state variable equation. As the scale of the circuit is continuously expanded, the amount of computation using existing simulation method is large, thus the requirement for real-time simulation is difficult to meet.

### SUMMARY OF THE INVENTION

In view of this, the present application proposes a method and apparatus for circuit simulation, for reducing the amount of computation for circuit simulation.

To achieve the above object, the schemes proposed are as follows:

A method for circuit simulation, comprising:

Partitioning circuit into a first simulation circuit and a second simulation circuit, which are connected through at least one port, wherein circuit elements in the first simulation circuit are linear-time-invariant;

In each simulation time-step, comprising the steps of:

Generating an equivalent circuit of the first simulation circuit at present simulation time-point, based on port current of simulation time-points prior to present simulation time-point;

Simulating the circuit consisting of the equivalent circuit and the second simulation circuit, based on a preset simulation algorithm, to obtain unknowns of the second simulation circuit as well as port current at present simulation time-point;

or,

Generating an equivalent circuit of the first simulation circuit at present simulation time-point, based on port voltage of simulation time-points prior to present simulation time-point;

Simulating the circuit consisting of the equivalent circuit and the second simulation circuit, based on a preset simulation algorithm, to obtain unknowns of the second simulation circuit as well as port voltage at present simulation time-point.

Preferably, if the first simulation circuit contains unknowns, the method further comprising: calculating unknowns of the first simulation circuit based on port current or port voltage.

Preferably, generating an equivalent circuit of the first simulation circuit at present simulation time-point, based on port current of simulation time-points prior to present simulation time-point, comprising:

Calculating equivalent open-circuit voltage and equivalent resistance of the equivalent circuit;

wherein the equivalent open-circuit voltage is:

$$[ {v}_{eq} ( t ) ] = [ {v}_{eq , 0} ( t ) ] + {\sum }_{j = 0}^{j < t} \{ [ {h}_{v - eq} ( t - j ) ] \times [ {i}_{port} ( j ) ] \}$$

and wherein the equivalent resistance is:

[R_{eq}]=[h_{v-eq}(0)]

where: t denotes time corresponding to present simulation time-point, j denotes time corresponding to port current, [v_{eq}(t)] denotes equivalent open-circuit voltage at time t, [v_{eq,0}(t)] denotes port voltage of the first simulation circuit under port open-circuit condition at time t, [h_{v-eq}(t−j)] denotes impulse-response of port voltage of the first simulation circuit to the port current at time (t−j), [iₚₒᵣₜ(j)] denotes port current at time j, [R_{eq}] denotes equivalent resistance, [h_{v-eq}(0)] denotes impulse-response of port voltage of the first simulation circuit to the port current at time 0;

Generating the equivalent circuit of the first simulation circuit based on the equivalent open-circuit voltage and the equivalent resistance.

Preferably, generating an equivalent circuit of the first simulation circuit at present simulation time-point, based on port voltage of simulation time-points prior to present simulation time-point, comprising:

Calculating equivalent short-circuit current and equivalent conductance of the equivalent circuit;

wherein the equivalent short-circuit current is:

$$[ {i}_{eq} ( t ) ] = [ {i}_{eq , 0} ( t ) ] + {\sum }_{j = 0}^{j < t} \{ [ {h}_{i - eq} ( t - j ) ] \times [ {v}_{port} ( j ) ] \}$$

and wherein the equivalent conductance is:

[G_{eq}]=[h_{i-eq}(0)]

where: t denotes time corresponding to present simulation time-point, j denotes time corresponding to port voltage, [i_{eq}(t)] denotes equivalent short-circuit current at time t, [i_{eq,0}(t)] denotes port current of the first simulation circuit under port short-circuit condition at time t, [h_{i-eq}(t−j)] denotes impulse-response of port current of the first simulation circuit to the port voltage at time (t−j), [vₚₒᵣₜ(j)] denotes port voltage at time j, [G_{eq}] denotes equivalent conductance, [h_{i-eq}(0)] denotes impulse-response of port current of the first simulation circuit to the port voltage at time 0;

Generating the equivalent circuit of the first simulation circuit based on the equivalent short-circuit current and the equivalent conductance.

Preferably, simulating the circuit consisting of the equivalent circuit and the second simulation circuit, based on a preset simulation algorithm, comprising:

Simulating the circuit consisting of the equivalent circuit and the second simulation circuit, using difference equation method or state variable method.

Preferably, calculating unknowns of the first simulation circuit based on port current, comprising:

Calculating unknown node voltage of the first simulation circuit from equation:

$$[ v ( t ) ] = [ {v}_{0} ( t ) ] + {\sum }_{j = 0}^{j = t} \{ [ {h}_{v} ( t - j ) ] \times [ {i}_{port} ( j ) ] \}$$

and/or calculating unknown branch current of the first simulation circuit from equation:

$$[ i ( t ) ] = [ {i}_{0} ( t ) ] + {\sum }_{j = 0}^{j = t} \{ [ {h}_{i} ( t - j ) ] \times [ {i}_{port} ( j ) ] \}$$

where: t denotes time corresponding to present simulation time-point, j denotes time corresponding to port current, [v(t)] denotes unknown node voltage of the first simulation circuit at time t, [v₀(t)] denotes unknown node voltage of the first simulation circuit under port open-circuit condition at time t, [hᵥ(t−j)] denotes impulse-response of unknown node voltage of the first simulation circuit to the port current at time (t−j), [iₚₒᵣₜ(j)] denotes port current at time j, [i(t)] denotes unknown branch current of the first simulation circuit at time t, [i₀(t)] denotes unknown branch current of the first simulation circuit under port open-circuit condition at time t, [hᵢ(t−j)] denotes impulse-response of unknown branch current of the first simulation circuit to the port current at time (t−j).

Preferably, calculating unknowns of the first simulation circuit based on port voltage, comprising:

Calculating unknown node voltage of the first simulation circuit from equation

$$[ v ( t ) ] = [ {v}_{0} ( t ) ] + {\sum }_{j = 0}^{j = t} \{ [ {h}_{v} ( t - j ) ] \times [ {v}_{port} ( j ) ] \}$$

and/or calculating unknown branch current of the first simulation circuit from equation

$$[ i ( t ) ] = [ {i}_{0} ( t ) ] + {\sum }_{j = 0}^{j = t} \{ [ {h}_{i} ( t - j ) ] \times [ {v}_{port} ( j ) ] \}$$

where: t denotes time corresponding to present simulation time-point, j denotes time corresponding to port voltage, [v(t)] denotes unknown node voltage of the first simulation circuit at time t, [v₀(t)] denotes unknown node voltage of the first simulation circuit under port short-circuit condition at time t, [hᵥ(t−j)] denotes impulse-response of unknown node voltage of the first simulation circuit to the port voltage at time (t−j), [vₚₒᵣₜ(j)] denotes port voltage at time j, [i(t)] denotes unknown branch current of the first simulation circuit at time t, [i₀(t)] denotes unknown branch current of the first simulation circuit under port short-circuit condition at time t, [hᵢ(t−j)] denotes impulse-response of unknown branch current of the first simulation circuit to the port voltage at time (t−j).

Preferably, calculating equivalent open-circuit voltage and equivalent resistance of the equivalent circuit, further comprising: Pre-calculating port voltage of the first simulation circuit under port open-circuit condition and the impulse-response of port voltage of the first simulation circuit to port current, using frequency-domain method or time-domain method.

Preferably, calculating equivalent short-circuit current and equivalent conductance of the equivalent circuit, further comprising: Pre-calculating port current of the first simulation circuit under port short-circuit condition and the impulse-response of port current of the first simulation circuit to port voltage, using frequency-domain method or time-domain method.

Preferably, calculating unknowns of the first simulation circuit based on port current, further comprising: Pre-calculating unknown node voltage of the first simulation circuit under port open-circuit condition and the impulse-response of unknown node voltage of the first simulation circuit to port current, and/or unknown branch current of the first simulation circuit under port open-circuit condition and the impulse-response of unknown branch current of the first simulation circuit to port current, using frequency-domain method or time-domain method.

Preferably, calculating unknowns of the first simulation circuit based on port voltage, further comprising: Pre-calculating unknown node voltage of the first simulation circuit under port short-circuit condition and the impulse-response of unknown node voltage of the first simulation circuit to port voltage, and/or unknown branch current of the first simulation circuit under port short-circuit condition and the impulse-response of unknown branch current of the first simulation circuit to port voltage, using frequency-domain method or time-domain method.

A circuit simulation apparatus, comprising:

A circuit partitioning unit, which is used for partitioning circuit into a first simulation circuit and a second simulation circuit, which are connected through at least one port, wherein circuit elements in the first simulation circuit are linear-time-invariant;

A first equivalent circuit generating unit, which is used for generating equivalent circuit of the first simulation circuit at present simulation time-point, based on port current of simulation time-points prior to present simulation time-point;

A first simulation unit, which is used for simulating the circuit consisting of the equivalent circuit generated by the first equivalent circuit generating unit and the second simulation circuit, to obtain unknowns of the second simulation circuit, as well as the port current of present simulation time-point, based on a preset algorithm;

A second equivalent circuit generating unit, which is used for generating equivalent circuit of the first simulation circuit at present simulation time-point, based on port voltage of simulation time-points prior to present simulation time-point;

A second simulation unit, which is used for simulating the circuit consisting of the equivalent circuit generated by the second equivalent circuit generating unit and the second simulation circuit, to obtain unknowns of the second simulation circuit, as well as the port voltage of present simulation time-point, based on a preset algorithm.

As can be seen from the above technical scheme, the present invention discloses a method and apparatus for circuit simulation. This method partitions circuit into a first simulation circuit and a second simulation circuit, wherein circuit elements of the first simulation circuit are linear-time-invariant. In each simulation time-step, generate equivalent circuit of first simulation circuit at present simulation time-point based on port current/port voltage. Further, simulate circuit consisting of the equivalent circuit and the second simulation circuit based on preset simulation algorithm to obtain the unknowns of the second simulation circuit as well as the port current or port voltage at the present simulation time-point. Compared with prior art, this invention reduces circuit scale by equivalence of linear part of circuit, namely, by representing the first simulation circuit by equivalent open-circuit voltage source in series with equivalent resistance or equivalent short-circuit current source in parallel with equivalent conductance. Thereby computation amount in simulation process is reduced to meet requirements for real-time simulation.

### BRIEF DESCRIPTION OF THE DRAWINGS

Below with the drawings in the present application example embodiment, be a clear example of the application of technical solutions implemented fully described, the described embodiments are merely part of embodiments of the present application, but not all embodiments. Based on the embodiments of the present application, and all other embodiments of the ordinary skill in the creative work did not make the premise obtained, are within the scope of protection of the present application.

FIG. 1 illustrates a flow diagram of circuit simulation method disclosed by an embodiment of the present invention.

FIG. 2 illustrates a connection diagram of an equivalent circuit of a first simulation circuit and a second simulation circuit in one embodiment of the invention.

FIG. 3 illustrates a flow diagram of a circuit simulation method disclosed by another embodiment of the present invention.

FIG. 4 illustrates a connection diagram of an equivalent circuit of a first simulation circuit and a second simulation circuit in another embodiment of the invention.

FIG. 5 illustrates a frequency-spectrum diagram disclosed by the invention.

FIG. 6 illustrates a structural schematic diagram of circuit simulation apparatus disclosed by another embodiment of the invention.

### DETAILED DESCRIPTION

The technical solution in the embodiments of the present application will be described clearly and comprehensively with reference to the accompanying drawings in the embodiments of the present application. Apparently, the described embodiments are merely a part of the embodiments of the present application, and not all embodiments. Based on the embodiments of the present application, all other embodiments obtained by persons of ordinary skill in the art without creative efforts belongs to the protection scope of the application.

### First Embodiment

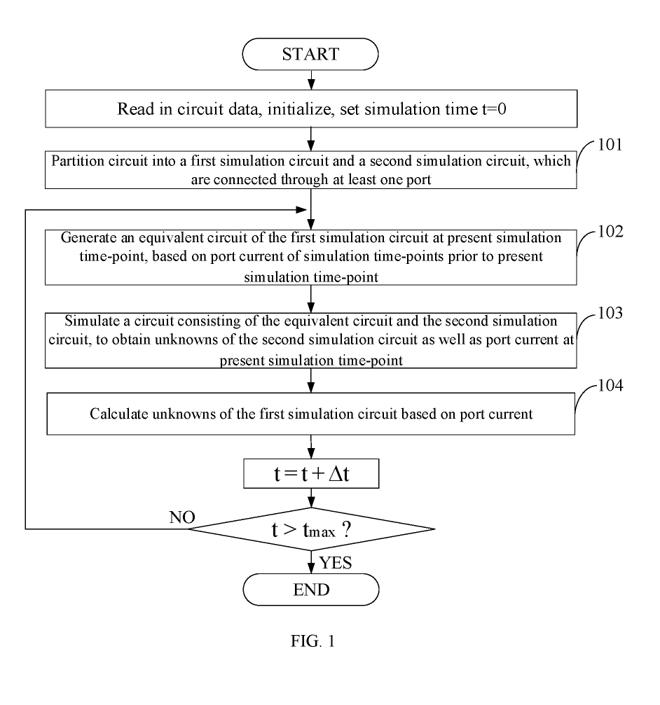

Referring to FIG. 1 for a flow diagram of circuit simulation method disclosed in an embodiment of the present invention.

As shown in FIG. 1, the method comprises:

101: Divide circuit into a first simulation circuit and a second simulation circuit which are connected through at least one port.

It should be noted that, to ensure the linear characteristic of the first simulation circuit, circuit elements in the first simulation circuit are linear-time-invariant.

In each simulation time-step, the method comprises the following steps:

102: Generate an equivalent circuit of the first simulation circuit at present simulation time-point, based on port current of simulation time-points prior to present simulation time-point.

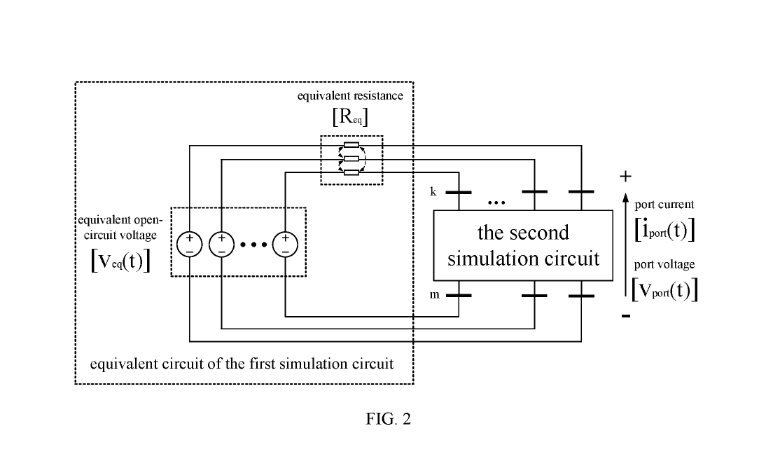

Referring to FIG. 2 for a connection diagram of the equivalent circuit of the first simulation circuit and the second simulation circuit disclosed in an embodiment of the present invention. The equivalent circuit of the first simulation circuit is equivalent open-circuit voltage source in series connection with equivalent resistance. Wherein the equivalent open-circuit voltage of the equivalent circuit comprises the following two components:
1) value of port voltage of the first simulation circuit at present simulation time-point, under port open-circuit condition;
2) weighted sum of port current of several simulation time-points prior to present simulation time-point, wherein the weight is the value of the impulse-response of port voltage of the first simulation circuit to the port current at time T (wherein T denotes the difference between the time corresponding to the present simulation time-point and the time corresponding to the port current).

The formula for calculations is:

$$[ {v}_{eq} ( t ) ] = [ {v}_{eq , 0} ( t ) ] + {\sum }_{j = 0}^{j < t} \{ [ {h}_{v - eq} ( t - j ) ] \times [ {i}_{port} ( j ) ] \}$$

where: t denotes time corresponding to present simulation time-point, j denotes time corresponding to port current, [v_{eq}(t)] denotes equivalent open-circuit voltage at time t, [v_{eq,0}(t)] denotes port voltage of the first simulation circuit under port open-circuit condition at time t, [h_{v-eq}(t−j)] denotes impulse-response of port voltage of the first simulation circuit to port current at time (t−j), [iₚₒᵣₜ(j)] denotes port current at time t.

Equivalent resistance of equivalent circuit:

[R_{eq}]=[h_{v-eq}(0)]

where [h_{v-eq}(0)] denotes impulse-response of port voltage of the first simulation circuit to port current at time 0.

Further, based on the form of equivalent open-circuit voltage source in series connection with equivalent resistance, generate equivalent circuit of the first simulation circuit.

103: Simulating circuit consisting of the equivalent circuit and the second simulation circuit, based on preset simulation algorithm, to obtain unknowns of the second simulation circuit as well as port current at the present simulation time-point.

Preferably, difference equation method or state variable method can be used to simulate the circuit consisting of the equivalent circuit of the first simulation circuit and the second simulation circuit, to obtain unknowns of the second simulation circuit, as well as the port current at the present simulation time-point.

It should be noted that, in an actual process, the first simulation circuit sometimes can also include unknowns, such as unknown node voltage and/or unknown branch current, thus, in other embodiments disclosed by present invention, the method further comprises:

104: Calculate unknowns of the first simulation circuit based on port current.

Wherein the unknown node voltage/unknown branch current in the first simulation circuit comprises the following two components:
1) unknown node voltage/unknown branch current of the first simulation circuit at present simulation time-point, under port open-circuit condition.
2) weighted sum of port current of several simulation time-points prior to present simulation time-point, wherein the weight is the value of the impulse-response of port voltage of the first simulation circuit to the port current at time T (where T denotes the difference between the time corresponding to the present simulation time-point and the time corresponding to the port current).

The specific calculation method is as follows:

Based on equation:

$$[ v ( t ) ] = [ {v}_{0} ( t ) ] + {\sum }_{j = 0}^{j = t} [ {h}_{v} ( t - j ) ] \times [ {i}_{port} ( j ) ]$$

calculate the unknown node voltage of the first simulation circuit;

Based on equation:

$$[ i ( t ) ] = [ {i}_{0} ( t ) ] + {\sum }_{j = 0}^{j = t} [ {h}_{i} ( t - j ) ] \times [ {i}_{port} ( j ) ]$$

calculate the unknown branch current of the first simulation circuit;
where: t denotes time corresponding to present simulation time-point, j denotes time corresponding to port current, [v(t)] denotes unknown node voltage of the first simulation circuit at time t, [v₀(t)] denotes unknown node voltage of the first simulation circuit under port open-circuit condition at time t, [hᵥ(t−j)] denotes impulse-response of unknown node voltage of the first simulation circuit to the port current at time (t−j), [iₚₒᵣₜ(j)] denotes port current at time j, [i(t)] denotes unknown branch current of the first simulation circuit at time t, [i₀(t)] denotes unknown branch current of the first simulation circuit under open-circuit condition at time t, [hᵢ(t−j)] denotes impulse-response of unknown branch current of the first simulation circuit to the port current at time (t−j).

As can be seen from the above technical scheme, the present invention discloses a method for circuit simulation. This method partitions the circuit into a first simulation circuit and a second simulation circuit, wherein the circuit elements of the first simulation circuit are linear-time-invariant. In each simulation time-step, based on the port current, pre-obtained port voltage of the first simulation circuit under port open-circuit condition, as well as pre-obtained impulse-response of the first simulation circuit to the port current, generate an equivalent circuit of the first simulation circuit at the present simulation time-point. Based on preset circuit simulation algorithm, the circuit consisting of the equivalent circuit and the second simulation circuit is simulated to obtain unknowns of the second simulation circuit as well as the port current at the present simulation time-point. Compared with prior art, the present invention reduces circuit scale by equivalence of linear portions of the circuit, i.e., the first simulation circuit, by representing the original first simulation circuit with equivalent open-circuit voltage source in series connection with equivalent resistance. Thereby computation amount of simulation process is reduced to meet the needs of real-time simulation.

Optionally, in the above embodiment, various methods can be used to obtain the response of the first simulation circuit (including: port voltage of first simulation circuit under port open-circuit condition, unknown node voltage of the first simulation circuit under the port open-circuit condition, unknown branch current of the first simulation circuit under the port open-circuit condition), as well as the impulse-response of the first simulation circuit to the port current (including: impulse-response of the port voltage of the first simulation circuit to the port current, unknown node voltage of the first simulation circuit to the port current, unknown branch current of the first simulation circuit to the port current).

### 1. Calculate Response of First Simulation Circuit Under Port Open-Circuit Condition Using Time-Domain Method

Set all connection ports of the first simulation circuit and the second simulation circuit to open-circuit. Use difference equation method or state variable method to obtain the response of the first simulation circuit under the port open-circuit condition (including: port voltage of the first simulation circuit under the port open-circuit condition, unknown node voltage of the first simulation circuit under the port open-circuit condition, unknown branch current of the first simulation circuit under the port open-circuit condition).

### 2. Calculate Impulse-Response of First Simulation Circuit to Port Current Using Time-Domain Method

Set all independent power sources of the first simulation circuit to zero, and simulate M times by using difference equation method or state variable method (where M is the number of ports connected between the first simulation circuit and the second simulation circuit). In each of the Mⱼ^{-th} simulation, the corresponding Mⱼ^{-th} port current is a unit-impulse current, and the other ports are open-circuit (current equals zero), through simulation the impulse-response vector of the first simulation circuit to the Mⱼ^{-th} port current is obtained. An M-column matrix comprising column vectors corresponding to M times of simulations is obtained, wherein the matrix is the impulse-response matrix of the first simulation circuit to the port current. The impulse-response of the first simulation circuit to the port current comprises: impulse-response of port voltage to the port current, impulse-response of unknown node voltage to port current, impulse-response of unknown branch current to port current.

### 3. Calculate Response of First Simulation Circuit Under Port Open-Circuit Condition Using Frequency-Domain Method.

Generate a preset frequency-spectrum. Referring to FIG. 5 for a frequency-spectrum diagram disclosed by the present invention. Let the simulation time-step size be Δt, simulation time window be 0˜(N−1)Δt, then: frequency interval of the preset frequency-spectrum is Δf=1/(2N−1)Δt, preset frequency-spectrum is 0˜(2N−1)Δf, the first half of the preset spectrum is 0˜NΔf, the second half of the preset frequency-spectrum is (N+1) Δf˜(2N−1) Δf. Set all independent power sources of the first simulation circuit to zero, for each frequency of the first half of the preset frequency-spectrum, the circuit is steady-state circuit, solve nodal equation using nodal method or modified nodal method. The specific steps comprising:

Take nodal method as an example, solve the following nodal voltage equation:

[Y_{node}(f)]×[v_{node,0}(f)]=[I_{node,0}(f)]

Wherein, [Y_{node}(f)] denotes the nodal conductance matrix of the first simulation circuit under frequency f. This matrix is generated based on the network topology and the frequency characteristics of the various elements. [I_{node, 0}(f)] denotes the node current injection vector of the first simulation circuit under frequency f. This vector is read from the power source data. [V_{node, 0}(f)] denotes the nodal voltage vector of the first simulation circuit under frequency f.

Under frequency f, the port voltage of the first simulation circuit under the port open-circuit condition is:

[V_{eq,0}(f)]=[V_{k,0}(f)]−[V_{m,0}(f)]

Wherein, [V_{k, 0}(f)] denotes the ‘from’ side node voltage of the equivalent open-circuit voltage under frequency f, [V_{m, 0}(f)] denotes the ‘to’ side node voltage of the equivalent open-circuit voltage under frequency f, [V_{k, 0}(f)] and [V_{m, 0}(f)] can be directly obtained from the node voltage vector of the first simulation circuit [V_{node, 0}(f)].

Under frequency f, the unknown node voltage of the first simulation circuit under the port open-circuit condition [V₀(f)] can be directly obtained from the node voltage vector of the first simulation circuit [V_{node, 0}(f)].

Under frequency f, the unknown branch current of the first simulation circuit under the port open-circuit condition:

$$[ {I}_{0} ( f ) ] = \frac{1}{{z}_{pq} ( f )} \cdot ( [ {V}_{p , 0} ( f ) ] - [ {V}_{q , 0} ( f ) ] )$$

Wherein, [V_{p, 0}(f)] denotes the ‘from’ side node voltage of the unknown current branch under frequency f, [V_{q, 0}(f)] denotes the ‘to’ side node voltage of the unknown current branch under frequency f, [V_{p, 0}(f)] and [V_{q, 0}(f)] can be directly obtained from the node voltage vector of the first simulation circuit [V_{node, 0}(f)], z_{pq}(f) denotes branch impedance of the unknown current branch under frequency f.

According to conjugate symmetry and periodicity of the frequency-spectrum, as shown in FIG. 5, the circuit response under each frequency of the second half of the preset frequency-spectrum can be obtained from the circuit response under each frequency of the first half of the preset frequency-spectrum.

After the circuit response under each frequency of the preset frequency-spectrum is obtained, perform inverse discrete Fourier transform (IDFT) or inverse fast Fourier transform (IFFT) on the frequency-spectrum of the circuit response, to obtain the circuit response value at each simulation time-point. Circuit response value at other time instant can be obtained by linear interpolation of circuit response value at each simulation time-point.

### 4. Calculate Impulse-Response of First Simulation Circuit to Port Current Using Frequency-Domain Method

Generate a preset frequency-spectrum. Referring to FIG. 5 for a frequency-spectrum diagram disclosed by the present invention. Let the simulation time-step size be Δt, simulation time window be 0˜(N−1)Δt, then: frequency interval of the preset frequency-spectrum is Δf=1/(2N−1)Δt, preset frequency-spectrum is 0˜(2N−1)Δf, the first half of the preset frequency-spectrum is 0˜NΔf, the second half of the preset frequency-spectrum is (N+1)Δf˜(2N−1)Δf. Set all independent power sources of the first simulation circuit to zero, at each frequencies of the first half of the preset frequency-spectrum, the circuit is steady-state circuit, solve nodal equation using nodal method or modified nodal method. Here a nodal method is used as an example. Solve the following nodal voltage equation:

[Y_{node}(f)]×[V_{node,impulse}(f)]=[I_{node,impulse}(f)]

Wherein, [Y_{node}(f)] denotes the nodal conductance matrix of the first simulation circuit under frequency f. This matrix is generated based on the network topology and the frequency characteristics of the various elements.

[I_{node, impulse}(f)] denotes the node current injection matrix of the first simulation circuit under frequency f. The matrix has M columns, wherein M is the number of ports. Column Mⱼ of the matrix is: the node current injection column vector when the Mⱼ^{-th} port current is the unit current and all the other independent power sources are set to zero.

[V_{node, impulse}(f)] denotes the node voltage matrix of the first simulation circuit under frequency f. The matrix has M columns, wherein M is the number of ports. Column Mⱼ of the matrix is: the response of node voltage to Mⱼ^{-th} port current column vector.

Under frequency f, the impulse-response of port voltage of the first simulation circuit to port current is:

[V_{eq,impulse}(f)]=[V_{k,impulse}(f)]−[V_{m,impulse}(f)]

Wherein, [V_{k, impulse}(f)] denotes the ‘from’ side node voltage of the equivalent open-circuit voltage under frequency f, [V_{m, impulse}(f)] represents the ‘to’ side node voltage of the equivalent open-circuit voltage under frequency f, [V_{k, impulse}(f)] and [V_{m, impulse}(f)] can be directly obtained from the node voltage vector of the first simulation circuit [V_{node, impulse}(f)].

Under frequency f, the impulse-response of unknown node voltage of the first simulation circuit to port current [Vᵢₘₚᵤₗₛₑ(f)] can be directly obtained from the node voltage vector of the first simulation circuit [V_{node, impulse}(f)].

Under frequency f, the impulse-response of unknown branch current of the first simulation circuit to port current:

$$[ {I}_{impulse} ( f ) ] = \frac{1}{{z}_{pq} ( f )} \cdot ( [ {V}_{p , impulse} ( f ) ] - [ {V}_{q , impulse} ( f ) ] )$$

Wherein, [V_{p, impulse}(f)] denotes the ‘from’ side node voltage of the unknown current branch under frequency f, [V_{q, impulse}(f)] denotes the ‘to’ side node voltage of the unknown current branch under frequency f, [V_{p, impulse}(f)] and [V_{q, impulse}(f)] can be directly obtained from the node voltage vector of the first simulation circuit [V_{node, impulse}(f)], z_{pq}(f) denotes branch impedance of the unknown current branch under frequency f.

According to conjugate symmetry and periodicity of the frequency-spectrum, as shown in FIG. 5, the circuit response under each frequency of the second half of the preset frequency-spectrum can be obtained from the circuit response under each frequency of the first half of the preset frequency-spectrum.

After the circuit response under each frequency of the preset frequency-spectrum is obtained, perform inverse discrete Fourier transform (IDFT) or inverse fast Fourier transform (IFFT) on the frequency-spectrum of the circuit response, to obtain the circuit response value at each simulation time-point. Circuit response value at other time instant can be obtained by linear interpolation of circuit response value at each simulation time-point.

### Second Embodiment

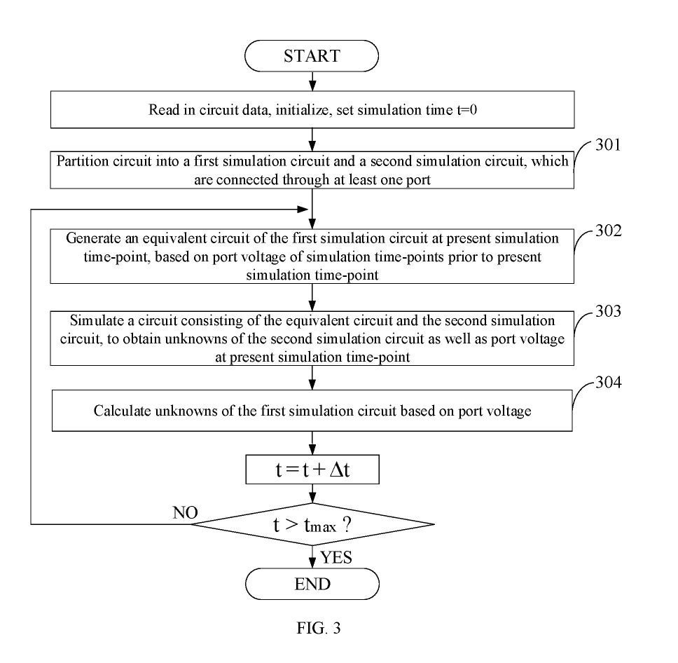

Referring to FIG. 3 for a flow diagram of circuit simulation method disclosed in an embodiment of the present invention.

As shown in FIG. 3, the method comprises:

301: Divide circuit into a first simulation circuit and a second simulation circuit which are connected through at least one port.

It should be noted that, to ensure the linear characteristic of the first simulation circuit, circuit elements in the first simulation circuit are linear-time-invariant.

In each simulation time-step, the method comprises the following steps:

302: Generate an equivalent circuit of the first simulation circuit at present simulation time-point, based on port voltage of simulation time-points prior to present simulation time-point.

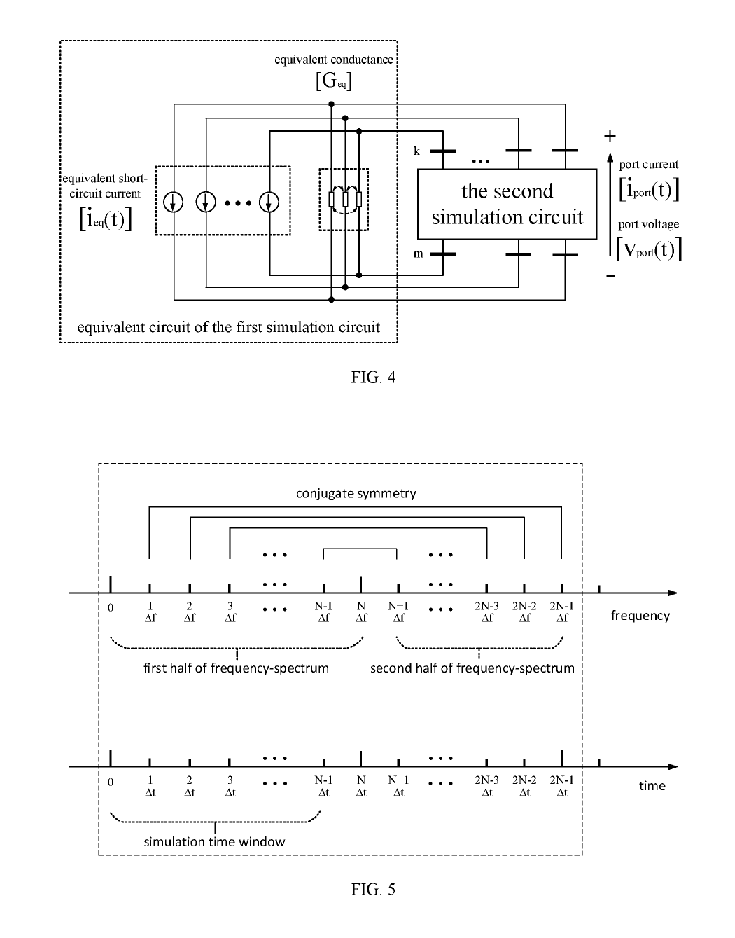

Referring to FIG. 4 for a connection diagram of the equivalent circuit of the first simulation circuit and the second simulation circuit disclosed in an embodiment of the present invention. The equivalent circuit of the first simulation circuit is equivalent short-circuit current source in parallel connection with equivalent conductance. Wherein the equivalent short-circuit current of the equivalent circuit comprises the following two components:
1) value of port current of the first simulation circuit at present simulation time-point, under port short-circuit condition;
2) weighted sum of port voltage of several simulation time-points prior to present simulation time-point, wherein the weight is the value of the impulse-response of port current of the first simulation circuit to the port voltage at time T (wherein T denotes the difference between the time corresponding to the present simulation time-point and the time corresponding to the port voltage).

The formula for calculations is:

$$[ {i}_{eq} ( t ) ] = [ {i}_{eq , 0} ( t ) ] + {\sum }_{j = 0}^{j < t} [ {h}_{i - eq} ( t - j ) ] \times [ {v}_{port} ( j ) ]$$

where:

t denotes time corresponding to present simulation time-point,

j denotes time corresponding to port voltage,

[i_{eq}(t)] denotes equivalent short-circuit current at time t,

[i_{eq,0}(t)] denotes port current of the first simulation circuit under port short-circuit condition at time t,

[h_{i-eq}(t−j)] denotes impulse-response of port current of the first simulation circuit to port voltage at time (t−j),

[vₚₒᵣₜ(j)] denotes port voltage at time t.

Equivalent conductance of equivalent circuit:

[G_{eq}]=[h_{i-eq}(0)]

Where [h_{i-eq}(0)] denotes impulse-response of port current of the first simulation circuit to port voltage at time 0.

Further, based on the form of equivalent short-circuit current source in parallel connection with equivalent conductance, generate equivalent circuit of the first simulation circuit.

303: Simulate circuit consisting of the equivalent circuit and the second simulation circuit, based on preset simulation algorithm, to obtain unknowns of the second simulation circuit as well as port voltage at the present simulation time-point.

Preferably, difference equation method or state variable method can be used to simulate the circuit consisting of the equivalent circuit of the first simulation circuit and the second simulation circuit, to obtain unknowns of the second simulation circuit, as well as the port voltage at the present simulation time-point.

It should be noted that, in an actual process, the first simulation circuit sometimes can also include unknowns, such as unknown node voltage and/or unknown branch current, thus, in other embodiments disclosed by present invention, the method further comprises:

304: Calculate unknowns of the first simulation circuit based on port voltage.

Wherein the unknown node voltage/unknown branch current in the first simulation circuit comprises the following two components:
1) unknown node voltage/unknown branch current of the first simulation circuit at present simulation time-point, under port short-circuit condition.
2) weighted sum of port voltage of several simulation time-points prior to present simulation time-point, wherein the weight is the value of the impulse-response of port current of the first simulation circuit to the port voltage at time T (where T denotes the difference between the time corresponding to the present simulation time-point and the time corresponding to the port voltage).

The specific calculation method is as follows:

Based on equation:

$$[ v ( t ) ] = [ {v}_{0} ( t ) ] + {\sum }_{j = 0}^{j = t} [ {h}_{v} ( t - j ) ] \times [ {v}_{port} ( j ) ]$$

calculate the unknown node voltage of the first simulation circuit;

Based on equation:

$$[ i ( t ) ] = [ {i}_{0} ( t ) ] + {\sum }_{j = 0}^{j = t} [ {h}_{i} ( t - j ) ] \times [ {v}_{port} ( j ) ]$$

calculate the unknown branch current of the first simulation circuit;

where:

t denotes time corresponding to present simulation time-point

j denotes time corresponding to port voltage

[v(t)] denotes unknown node voltage of the first simulation circuit at time t

[v₀(t)] denotes unknown node voltage of the first simulation circuit under port short-circuit condition at time t

[hᵥ(t−j)] denotes impulse-response of unknown node voltage of the first simulation circuit to the port voltage at time (t−j)

[vₚₒᵣₜ(j)] denotes port voltage at time j

[i(t)] denotes unknown branch current of the first simulation circuit at time t

[i₀(t)] denotes unknown branch current of the first simulation circuit under port short-circuit condition at time t

[hᵢ(t−j)] denotes impulse-response of unknown branch current of the first simulation circuit to the port voltage at time (t−j).

As can be seen from the above technical scheme, the present invention discloses a method for circuit simulation. This method partitions the circuit into a first simulation circuit and a second simulation circuit, wherein the circuit elements of the first simulation circuit are linear-time-invariant. In each simulation time-step, based on the port voltage, pre-obtained port current of the first simulation circuit under port short-circuit condition, as well as pre-obtained impulse-response of the first simulation circuit to the port voltage, generate an equivalent circuit of the first simulation circuit at the present simulation time-point. Based on preset circuit simulation algorithm, the circuit consisting of the equivalent circuit and the second simulation circuit is simulated to obtain unknowns of the second simulation circuit as well as the port voltage at the present simulation time-point. Compared with prior art, the present invention reduces circuit scale by equivalence of linear portions of the circuit, i.e., the first simulation circuit, by representing the original first simulation circuit with equivalent short-circuit current source in parallel connection with equivalent conductance. Thereby computation amount of simulation process is reduced to meet the needs of real-time simulation.

Optionally, in the above embodiment, various methods can be used to obtain the response of the first simulation circuit (including: port voltage of first simulation circuit under port short-circuit condition, unknown node voltage of the first simulation circuit under the port short-circuit condition, unknown branch current of the first simulation circuit under the port short-circuit condition), as well as the impulse-response of the first simulation circuit to the port voltage (including: impulse-response of the port current of the first simulation circuit to the port voltage, unknown node voltage of the first simulation circuit to the port voltage, unknown branch current of the first simulation circuit to the port voltage).

### 1. Calculate Response of First Simulation Circuit Under Port Short-Circuit Condition Using Time-Domain Method

Set all connection ports of the first simulation circuit and the second simulation circuit to short-circuit. Use difference equation method or state variable method to obtain the response of the first simulation circuit under the port short-circuit condition (including: the port current of the first simulation circuit under the port short-circuit condition, unknown node voltage of the first simulation circuit under the port short-circuit condition, unknown branch current of the first simulation circuit under the port short-circuit condition).

### 2. Calculate Impulse-Response of First Simulation Circuit to Port Voltage Using Time-Domain Method

Set all independent power sources of the first simulation circuit to zero, and simulate M times by using difference equation method or state variable method (where M is the number of ports connected between the first simulation circuit and the second simulation circuit). In each of the Mⱼ^{-th} simulation, the corresponding Mⱼ^{-th} port current is a unit-impulse voltage, and the other ports are short-circuit (voltage equals zero), through simulation the impulse-response vector of the first simulation circuit to the Mⱼ^{-th} port voltage is obtained. An M-column matrix comprising column vectors corresponding to M times of simulations is obtained, wherein the matrix is the impulse-response matrix of the first simulation circuit to the port voltage. The impulse-response of the first simulation circuit to the port voltage comprises: impulse-response of port current to the port voltage, impulse-response of unknown node voltage to port voltage, impulse-response of unknown branch current to port voltage.

### 3. Calculate Response of First Simulation Circuit Under Port Short-Circuit Condition Using Frequency-Domain Method.

Generate a preset frequency-spectrum. Referring to FIG. 5 for a frequency-spectrum diagram disclosed by the present invention. Let the simulation time-step size be Δt, simulation time window be 0˜(N−1)Δt, then: frequency interval of the preset frequency-spectrum is Δf=1/(2N−1)Δt, preset frequency-spectrum is 0˜(2N−1)Δf, the first half of the preset frequency-spectrum is 0˜NΔf, the second half of the preset frequency-spectrum is (N+1) Δf˜(2N−1) Δf. Set all independent power sources of the first simulation circuit to zero, for each frequency of the first half of the preset frequency-spectrum, the circuit is steady-state circuit, solve nodal equation using nodal method or modified nodal method. The specific steps comprising:

Take modified nodal method as an example, solve the following nodal voltage equation:

[Y_{node}(f)]×[v_{node,0}(f)]=[I_{node,0}(f)]

Wherein, [Y_{node}(f)] denotes the modified nodal conductance matrix of the first simulation circuit under frequency f. This matrix is generated based on the network topology and the frequency characteristics of the various elements. [I_{node, 0}(f)] denotes the mixed node current injection-independent voltage source branch voltage vector of the first simulation circuit under frequency f. This vector is read from the power source data. [V_{node, 0}(f)] denotes the mixed node voltage-independent voltage source branch current vector of the first simulation circuit under frequency f.

Under frequency f, the port current of the first simulation circuit under the port short-circuit condition [I_{eq, 0}(f)] can be directly obtained from mixed node voltage-independent voltage source branch current vector of the first simulation circuit [V_{node, 0}(f)].

Under frequency f, the unknown node voltage of the first simulation circuit under the port short-circuit condition [V₀(f)] can be directly obtained from mixed node voltage-independent voltage source branch current vector of the first simulation circuit [V_{node, 0}(f)].

Under frequency f, the unknown branch current of the first simulation circuit under the port short-circuit condition:

$$[ {I}_{0} ( f ) ] = \frac{1}{{z}_{pq} ( f )} \cdot ( [ {V}_{p , 0} ( f ) ] - [ {V}_{q , 0} ( f ) ] )$$

Wherein, [V_{p, 0}(f)] denotes the ‘from’ side node voltage of the unknown current branch under frequency f, [V_{q, 0}(f)] denotes the ‘to’ side node voltage of the unknown current branch under frequency f, [V_{p, 0}(f)] and [V_{q, 0}(f)] can be directly obtained from mixed node voltage-independent voltage source branch current vector of the first simulation circuit [V_{node, 0}(f)], z_{pq}(f) denotes branch impedance of the unknown current branch under frequency f.

According to conjugate symmetry and periodicity of the frequency-spectrum, as shown in FIG. 5, the circuit response under each frequency of the second half of the preset frequency-spectrum can be obtained from the circuit response under each frequency of the first half of the preset frequency-spectrum.

After the circuit response under each frequency of the preset frequency-spectrum is obtained, perform inverse discrete Fourier transform (IDFT) or inverse fast Fourier transform (IFFT) on the frequency-spectrum of the circuit response, to obtain the circuit response value at each simulation time-point. Circuit response value at other time instant can be obtained by linear interpolation of circuit response value at each simulation time-point.

### 4. Calculate Impulse-Response of First Simulation Circuit to Port Voltage Using Frequency-Domain Method

Generate a preset frequency-spectrum. Referring to FIG. 5 for a frequency-spectrum diagram disclosed by the present invention. Let the simulation time-step size be Δt, simulation time window be 0˜(N−1)Δt, then: frequency interval of the preset frequency-spectrum is Δf=1/(2N−1)Δt, preset frequency-spectrum is 0˜(2N−1)Δf, the first half of the preset frequency-spectrum is 0˜NΔf, the second half of the preset frequency-spectrum is (N+1)Δf˜(2N−1)Δf.

Set all independent power sources of the first simulation circuit to zero, at each frequency of the first half of the preset frequency-spectrum, solve equation under frequency f using modified nodal method:

[Y_{node}(f)]×[V_{node,impulse}(f)]=[I_{node,impulse}(f)]

Wherein, [Y_{node}(f)] denotes the modified nodal conductance matrix of the first simulation circuit under frequency f. This matrix is generated based on the network topology and the frequency characteristics of the various elements.

[I_{node, impulse}(f)] denotes the mixed node current injection-independent voltage source branch voltage matrix of the first simulation circuit under frequency f. The matrix has M columns, wherein M is the number of ports. Column Mⱼ of the matrix is: the mixed node current injection-independent voltage source branch current column vector when the Mⱼ^{-th} port voltage is the unit current and all the other independent power sources are set to zero.

[V_{node, impulse}(f)] denotes the mixed node voltage-independent voltage source branch current matrix of the first simulation circuit under frequency f. The matrix has M columns, wherein M is the number of ports. Column Mⱼ of the matrix is: the response of mixed node voltage-independent voltage source branch current to Mⱼ^{-th} port voltage column vector.

Under frequency f, the impulse-response of port current of the first simulation circuit to port voltage [V_{node, impulse}(f)] can be directly obtained from the mixed node voltage-independent voltage source branch current matrix of the first simulation circuit [V_{node, impulse}(f)].

Under frequency f, the impulse-response of unknown node voltage of the first simulation circuit to port voltage [Vᵢₘₚᵤₗₛₑ(f)] can be directly obtained from the mixed node voltage-independent voltage source branch current matrix of the first simulation circuit [V_{node, impulse}(f)].

Under frequency f, the impulse-response of unknown branch current of the first simulation circuit to port voltage:

$$[ {I}_{impulse} ( f ) ] = \frac{1}{{z}_{pq} ( f )} \cdot ( [ {V}_{p , impulse} ( f ) ] - [ {V}_{q , impulse} ( f ) ] )$$

Wherein, [V_{p, impulse}(f)] denotes the ‘from’ side nodal voltage of the unknown current branch under frequency f, [V_{q, impulse}(f)] denotes the ‘to’ side nodal voltage of the unknown current branch under frequency f, [V_{p, impulse}(f)] and [V_{q, impulse}(f)] can be directly obtained from the mixed node voltage-independent voltage source branch current matrix of the first simulation circuit [V_{node, impulse}(f)], z_{pq}(f) denotes branch impedance of the unknown current branch under frequency f

According to conjugate symmetry and periodicity of the frequency-spectrum, as shown in FIG. 5, the circuit response under each frequency of the second half of the preset frequency-spectrum can be obtained from the circuit response under each frequency of the first half of the preset frequency-spectrum.

After the circuit response under each frequency of the preset frequency-spectrum is obtained, perform inverse discrete Fourier transform (IDFT) or inverse fast Fourier transform (IFFT) on the frequency-spectrum of the circuit response, to obtain the circuit response value at each simulation time-point. Circuit response value at other time instant can be obtained by linear interpolation of circuit response value at each simulation time-point.

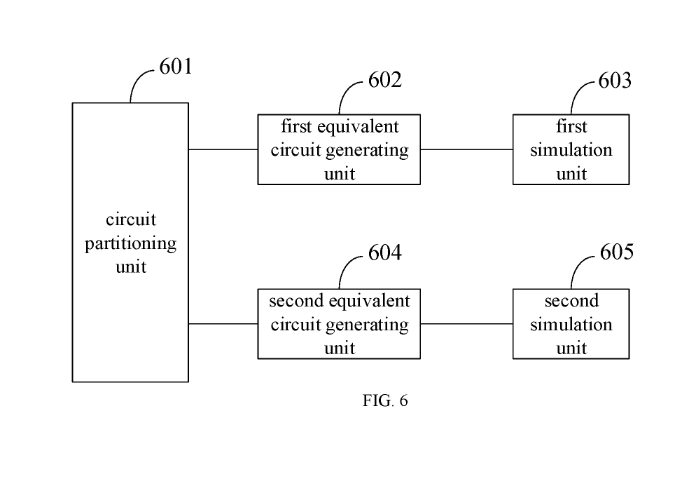

FIG. 6 illustrates a circuit simulation apparatus disclosed by another embodiment of the present invention.

As can be seen from FIG. 6, the apparatus comprising:

Circuit partitioning unit 601, which is used for partitioning the circuit into a first simulation circuit and a second simulation circuit, which are connected through at least one port, wherein circuit elements in the first simulation circuit are linear-time-invariant;

The first equivalent circuit generating unit 602, which is used for generating equivalent circuit of the first simulation circuit at present simulation time-point, based on port current of simulation time-points prior to present simulation time-point;

The first simulation unit 603, which is used for simulating the circuit consisting of the equivalent circuit generated by the first equivalent circuit generating unit and the second simulation circuit, obtaining unknowns of the second simulation circuit, as well as the port current at present simulation time-point, based on a preset algorithm;

The second equivalent circuit generating unit 604, which is used for generating equivalent circuit of the first simulation circuit at present simulation time-point, based on port voltage of simulation time-points prior to present simulation time-point;

The second simulation unit 605, which is used for simulating the circuit consisting of the equivalent circuit generated by the second equivalent circuit generating unit and the second simulation circuit, obtaining unknowns of the second simulation circuit, as well as the port voltage at present simulation time-point, based on a preset algorithm.

Finally, it should be noted that, as used herein, relational terms such as first and second, and the like are merely used to distinguish one entity or another entity operation or operations separate, and do not necessarily require or imply that these entities the actual existence of any such relationship or order between or operations. Moreover, the term “comprising”, “including” or any other variation thereof are intended to cover a non-exclusive inclusion, such that a series of factors including the process, method, article, or apparatus includes not only those elements, but also not explicitly listed the other elements, or further comprising for such process, method, article or device inherent feature. Without more constraints, by the statement “includes a . . . ” defining element does not exclude the presence of other elements including the same elements process, method, article or device.

Various embodiments of the present specification using progressive manner described, different from all the other embodiments of the highlights of each example embodiment, the same or similar portion between the various embodiments can see each other.

The above description of the disclosed embodiments, so that the skilled in the art to make or use the present application. These various modifications to the field of professional and technical personnel embodiments will be apparent, the general principles defined herein may be without departing from the spirit or scope of the present application, and implemented in other embodiments. Accordingly, the application will not be limited to these embodiments shown herein, but is to be accorded the consistent with the principles disclosed herein, and novel features of the widest range.

What is claimed is:

1. A method for circuit simulation, comprising:
partitioning circuit into a first simulation circuit and a second simulation circuit, which are connected through at least one port, wherein circuit elements in the first simulation circuit are linear-time-invariant;
in each simulation time-step, comprising the steps of:
generating an equivalent circuit of the first simulation circuit at present simulation time-point, based on port current of simulation time-points prior to present simulation time-point;
simulating the circuit consisting of the equivalent circuit and the second simulation circuit, based on a preset simulation algorithm, to obtain unknowns of the second simulation circuit as well as port current at present simulation time-point;
or,
generating an equivalent circuit of the first simulation circuit at present simulation time-point, based on port voltage of simulation time-points prior to present simulation time-point;
simulating the circuit consisting of the equivalent circuit and the second simulation circuit, based on a preset simulation algorithm, to obtain unknowns of the second simulation circuit as well as port voltage at present simulation time-point.

2. The method as described in claim 1, wherein if the first simulation circuit contains unknowns, the method further comprising:
calculating unknowns of the first simulation circuit based on port current or port voltage.

3. The method as described in claim 1, wherein generating an equivalent circuit of the first simulation circuit at present simulation time-point, based on port current of simulation time-points prior to present simulation time-point, comprising:
calculating equivalent open-circuit voltage and equivalent resistance of the equivalent circuit;
wherein the equivalent open-circuit voltage is:
$$[ {v}_{eq} ( t ) ] = [ {v}_{eq , 0} ( t ) ] + {\sum }_{j = 0}^{j < t} \{ [ {h}_{v - eq} ( t - j ) ] \times [ {i}_{port} ( j ) ] \} ,$$
and wherein the equivalent resistance is:
[R_{eq}]=[h_{v-eq}(0)]
where: t denotes time corresponding to present simulation time-point, j denotes time corresponding to port current, [v_{eq}(t)] denotes equivalent open-circuit voltage at time t, [v_{eq,0}(t)] denotes port voltage of the first simulation circuit under port open-circuit condition at time t, [h_{v-eq}(t−j)] denotes impulse-response of port voltage of the first simulation circuit to the port current at time (t−j), [iₚₒᵣₜ(j)] denotes port current at time j, [R_{eq}] denotes equivalent resistance, [h_{v-eq}(0)] denotes impulse-response of port voltage of the first simulation circuit to the port current at time 0;
generating the equivalent circuit of the first simulation circuit based on the equivalent open-circuit voltage and the equivalent resistance.

4. The method as described in claim 1, wherein generating an equivalent circuit of the first simulation circuit at present simulation time-point, based on port voltage of simulation time-points prior to present simulation time-point, comprising:
calculating equivalent short-circuit current and equivalent conductance of the equivalent circuit;
wherein the equivalent short-circuit current is:
$$[ {i}_{eq} ( t ) ] = [ {i}_{eq , 0} ( t ) ] + {\sum }_{j = 0}^{j < t} \{ [ {h}_{i - eq} ( t - j ) ] \times [ {v}_{port} ( j ) ] \}$$
and wherein the equivalent conductance is:
[G_{eq}]=[h_{i-eq}(0)]
where: t denotes time corresponding to present simulation time-point, j denotes time corresponding to port voltage, [i_{eq}(t)] denotes equivalent short-circuit current at time t, [i_{eq,0}(t)] denotes port current of the first simulation circuit under port short-circuit condition at time t, [h_{i-eq}(t−j)] denotes impulse-response of port current of the first simulation circuit to the port voltage at time (t−j), [vₚₒᵣₜ(j)] denotes port voltage at time j, [G_{eq}] denotes equivalent conductance, [h_{i-eq}(0)] denotes impulse-response of port current of the first simulation circuit to the port voltage at time 0;
generating the equivalent circuit of the first simulation circuit based on the equivalent short-circuit current and the equivalent conductance.

5. The method as described in claim 1, wherein simulating the circuit consisting of the equivalent circuit and the second simulation circuit, based on a preset simulation algorithm, comprising:
simulating the circuit consisting of the equivalent circuit and the second simulation circuit, using difference equation method or state variable method.

6. The method as described in claim 2, wherein calculating unknowns of the first simulation circuit based on port current, comprising:
calculating unknown node voltage of the first simulation circuit from equation:
$$[ v ( t ) ] = [ {v}_{0} ( t ) ] + {\sum }_{j = 0}^{j = t} \{ [ {h}_{v} ( t - j ) ] \times [ {i}_{port} ( j ) ] \}$$
and/or calculating unknown branch current of the first simulation circuit from equation:
$$[ i ( t ) ] = [ {i}_{0} ( t ) ] + {\sum }_{j = 0}^{j = t} \{ [ {h}_{i} ( t - j ) ] \times [ {i}_{port} ( j ) ] \}$$
where: t denotes time corresponding to present simulation time-point, j denotes time corresponding to port current, [v(t)] denotes unknown node voltage of the first simulation circuit at time t, [v₀(t)] denotes unknown node voltage of the first simulation circuit under port open-circuit condition at time t, [hᵥ(t−j)] denotes impulse-response of unknown node voltage of the first simulation circuit to the port current at time (t−j), [iₚₒᵣₜ(j)] denotes port current at time j, [i(t)] denotes unknown branch current of the first simulation circuit at time t, [i₀(t)] denotes unknown branch current of the first simulation circuit under port open-circuit condition at time t, [hᵢ(t−j)] denotes impulse-response of unknown branch current of the first simulation circuit to the port current at time (t−j).

7. The method as described in claim 2, wherein calculating unknowns of the first simulation circuit based on port voltage, comprising:
calculating unknown node voltage of the first simulation circuit from equation
$$[ v ( t ) ] = [ {v}_{0} ( t ) ] + {\sum }_{j = 0}^{j = t} \{ [ {h}_{v} ( t - j ) ] \times [ {v}_{port} ( j ) ] \}$$
and/or calculating unknown branch current of the first simulation circuit from equation
$$[ i ( t ) ] = [ {i}_{0} ( t ) ] + {\sum }_{j = 0}^{j = t} \{ [ {h}_{i} ( t - j ) ] \times [ {v}_{port} ( j ) ] \}$$
where: t denotes time corresponding to present simulation time-point, j denotes time corresponding to port voltage, [v(t)] denotes unknown node voltage of the first simulation circuit at time t, [v₀(t)] denotes unknown node voltage of the first simulation circuit under port short-circuit condition at time t, [hᵥ(t−j)] denotes impulse-response of unknown node voltage of the first simulation circuit to the port voltage at time (t−j), [vₚₒᵣₜ(j)] denotes port voltage at time j, [i(t)] denotes unknown branch current of the first simulation circuit at time t, [i₀(t)] denotes unknown branch current of the first simulation circuit under port short-circuit condition at time t, [hᵢ(t−j)] denotes impulse-response of unknown branch current of the first simulation circuit to the port voltage at time (t−j).

8. The method as described in claim 3, wherein calculating equivalent open-circuit voltage and equivalent resistance of the equivalent circuit, comprising:
pre-calculating port voltage of the first simulation circuit under port open-circuit condition and the impulse-response of port voltage of the first simulation circuit to port current, using frequency-domain method or time-domain method.

9. The method as described in claim 4, wherein calculating equivalent short-circuit current and equivalent conductance of the equivalent circuit, comprising:
pre-calculating port current of the first simulation circuit under port short-circuit condition and the impulse-response of port current of the first simulation circuit to port voltage, using frequency-domain method or time-domain method.

10. The method as described in claim 6, wherein calculating unknowns of the first simulation circuit based on port current, comprising:
pre-calculating unknown node voltage of the first simulation circuit under port open-circuit condition and the impulse-response of unknown node voltage of the first simulation circuit to port current, and/or unknown branch current of the first simulation circuit under port open-circuit condition and the impulse-response of unknown branch current of the first simulation circuit to port current, using frequency-domain method or time-domain method.

11. The method as described in claim 7, wherein calculating unknowns of the first simulation circuit based on port voltage, comprising:
pre-calculating unknown node voltage of the first simulation circuit under port short-circuit condition and the impulse-response of unknown node voltage of the first simulation circuit to port voltage, and/or unknown branch current of the first simulation circuit under port short-circuit condition and the impulse-response of unknown branch current of the first simulation circuit to port voltage, using frequency-domain method or time-domain method.

12. A circuit simulation apparatus, comprising:
a circuit partitioning unit, which is used for partitioning circuit into a first simulation circuit and a second simulation circuit, which are connected through at least one port, wherein circuit elements in the first simulation circuit are linear-time-invariant;
a first equivalent circuit generating unit, which is used for generating equivalent circuit of the first simulation circuit at present simulation time-point, based on port current of simulation time-points prior to present simulation time-point;
a first simulation unit, which is used for simulating the circuit consisting of the equivalent circuit generated by the first equivalent circuit generating unit and the second simulation circuit, to obtain unknowns of the second simulation circuit, as well as the port current of present simulation time-point, based on a preset algorithm;
a second equivalent circuit generating unit, which is used for generating equivalent circuit of the first simulation circuit at present simulation time-point, based on port voltage of simulation time-points prior to present simulation time-point;
a second simulation unit, which is used for simulating the circuit consisting of the equivalent circuit generated by the second equivalent circuit generating unit and the second simulation circuit, to obtain unknowns of the second simulation circuit, as well as the port voltage of present simulation time-point, based on a preset algorithm.
